(19) United States
(12) Patent Application Publication
(10) Pub. No.: US 2026/0005550 A1
(43) Pub. Date: Jan. 1, 2026

(54) WIRELESS CHARGING DEVICE HOLDER

(71) Applicant: Yank Technologies, Inc., Brooklyn, NY (US)

(72) Inventors: Monika CHAUDHARI, Brooklyn, NY (US); Joshua Aaron YANKOWITZ, Brooklyn, NY (US)

(21) Appl. No.: 19/320,841

(22) Filed: Sep. 5, 2025

Related U.S. Application Data
(63) Continuation of application No. PCT/US2024/018934, filed on Mar. 7, 2024.
(60) Provisional application No. 63/488,814, filed on Mar. 7, 2023.

(51) Int. Cl. H02J 50/12; B60R 11/00; B60R 11/02; B60R 16/03; H02J 50/00

(52) U.S. Cl. CPC H02J 50/12; B60R 11/02; B60R 16/03; H02J 50/005; B60R 2011/0017

(57) ABSTRACT

Embodiments of a wireless charging device holder are described. In some aspects, a wireless power system for installation in proximity to a window of a vehicle includes a receiver holder configured to receive an electronic device for wireless charging. The receiver holder is configured to be mounted to the window of the vehicle and includes a receiver antenna placed at an acute angle or perpendicular relative to a placement of the electronic device and placed parallel relative to a transmitter unit and a printed circuit board placed parallel or perpendicular to the receiver antenna. The system further includes the transmitter unit configured to transmit wireless power to the receiver holder. The transmitter unit is configured to be embedded near the receiver holder within a console, a panel, a pillar, a car seat, or a door of the vehicle.

### CROSS-REFERENCE TO RELATED APPLICATION

This application is a continuation and claims priority to International Application No. PCT/US2024/018934, filed on Mar. 7, 2024, which claims priority to U.S. Provisional Patent Application No. 63/488,814, filed on Mar. 7, 2023, the disclosures of which are hereby incorporated by reference herein in their entirety.

### TECHNICAL FIELD

The present document relates to wireless power transmission technology.

### BACKGROUND

The number of devices that use a rechargeable power source is ever increasing. To solve the operational issues associated with wired power charging solutions, in the recent years, wireless charging technology has been introduced and being used primarily for recharging mobile phones. In the next few years, the use of wireless charging is expected to increase even more for an even wider range of electronic devices. In this way, wireless power can be a means of enabling new features for next-generation devices.

### BRIEF SUMMARY

Techniques are disclosed for a wireless charging receiver holder system that can provide greater power to electronics mounted above or near a transmitter unit. In this disclosure, the terms antennas and coils are used interchangeably.

In one example aspect, a wireless power system for installation in proximity to a window of a vehicle includes a receiver holder configured to receive an electronic device for wireless charging. The receiver holder is configured to be mounted to the window of the vehicle and includes a receiver antenna, placed at an acute angle or perpendicular relative to a placement of the electronic device and placed parallel relative to a transmitter unit, and a printed circuit board placed parallel or perpendicular to the receiver antenna. The printed circuit board includes tuning capacitors, a matching network, an AC-DC converter, a DC-DC converter, and/or a voltage regulation device. The system further includes the transmitter unit configured to transmit wireless power to the receiver holder. The transmitter unit is configured to be embedded near the receiver holder within a console, a panel, a pillar, a car seat, or a door of the vehicle. One or many transmitter and receiver antennas substantially resonate with capacitors at similar frequencies.

In another example aspect, a wireless power system for installation in proximity to a car seat of a vehicle includes a receiver holder configured to receive an electronic device for wireless charging. The receiver holder is configured to be mounted to the car seat of the vehicle and includes a receiver antenna, placed at an acute angle or perpendicular relative to a placement of the electronic device and placed parallel relative to a transmitter unit, and a printed circuit board placed parallel or perpendicular to the receiver antenna. The printed circuit board includes tuning capacitors, a matching network, an AC-DC converter, a DC-DC converter, and/or a voltage regulation device. The system further includes the transmitter unit configured to transmit wireless power to the receiver holder. The transmitter unit is configured to be embedded near the receiver holder within the car seat or under a floor of the vehicle. One or many transmitter and receiver antennas substantially resonate with capacitors at similar frequencies.

These, and other, aspects are disclosed throughout the document.

### BRIEF DESCRIPTION OF THE DRAWINGS

FIG. 1 depicts an example receiver flow chart according to some embodiments of the disclosed technology.

FIG. 2 depicts an example system implementation of a wireless charging device holder according to some embodiments of the disclosed technology.

FIG. 3 depicts an example receiver holder system with antenna, electronic device, and PCB according to some embodiments of the disclosed technology.

FIG. 4 depicts an example receiver holder system with perpendicular antenna placement according to some embodiments of the disclosed technology.

FIG. 5 depicts an example receiver holder system with labelled receiver antenna width and angle to the electronic device according to some embodiments of the disclosed technology.

FIG. 6A and FIG. 6B depict example receiver holder systems for car seat applications according to some embodiments of the disclosed technology.

FIG. 7 depicts an example receiver holder system for car seat applications with transmitter embedded into the back cushion according to some embodiments of the disclosed technology.

FIG. 8 depicts an example receiver holder system construction with shielding material and separation material according to some embodiments of the disclosed technology.

FIG. 9 depicts an example embedded headrest charging system with different example transmitter mounting locations according to some embodiments of the disclosed technology.

FIG. 10 depicts an example resonant inductive receiver system programmed for multiple power levels according to some embodiments of the disclosed technology.

FIG. 11 depicts an example resonant inductive receiver system programmed for multiple power levels with pass-through connector according to some embodiments of the disclosed technology.

### DETAILED DESCRIPTION

With the continued advancement of new wireless charging systems, the development of new receiver devices, especially for mobile electronics like phones and tablets, is increasingly playing an important role. Wireless charging can be a means of providing power to receiver devices for convenience, especially in areas that may be difficult or cumbersome to use traditional wiring cables.

Today, there are often instances where the receiver antenna and electronics are not directly integrated into the electronic device but need to be applied as an external device to receive the power from the transmitter unit and provide that power to the electronic device. For example, in many smartphones or tablets, there are inductive or Qi receivers, but there are not currently many devices with resonant inductive receivers embedded. Therefore, an external device, such as a receiver accessory, tablet case, phone case, computer, headphones, game controller, or other wireless communication devices, will need to be used with the electronic device in order to wirelessly receive power from the transmitter unit for resonant inductive systems.

However, there are often instances in which a traditional receiver accessory or case is not applicable or optimal for performance. For resonant inductive charging, developing high intrinsic quality (‘Q’) antennas is important design criteria to improve system efficiency, charging distance, and power delivered to the load. Intrinsic quality is the measure of inductive reactance over resistance. In other words, it is a measure of the energy stored over the energy dissipated for the antenna. It is a dimensionless parameter that is typically used as a barometer for antenna efficiency. The higher the ‘Q’ of the transmitter and receiver antennas, the better they will couple with one another. Nearby metal objects to the antennas can often ‘de-Q’ the antennas or reduce their intrinsic efficiency due to cross-coupling. Furthermore, the introduction of an electronic device with metal components or parts can unintendedly absorb some of the magnetic flux emanating from the transmitter unit, further reducing system performance.

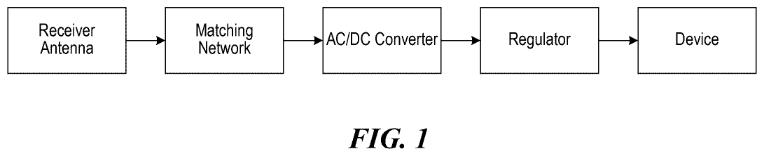

FIG. 1 illustrates an example receiver flow chart. In particular, FIG. 1 shows a basic flow chart for an example receiver system for devices, such as smartphones, tablets, computers, infotainment systems, and other electronic devices. In this system, at least one transmitter outputs a high frequency AC signal, such as 85 kHz, 100 kHz, 6.78 MHz, 13.56 MHz, or 27.12 MHz that can be captured by the receiver(s). The receiver antenna substantially couples with the transmitter antenna by capacitively tuning and matching to the desired impedance. It then converts the AC signal into DC, such as via a bridge rectifier, and regulates that voltage for the device. Depending on the implementation, an additional circuit may be necessary to appropriately regulate the power, voltage, and/or current for the rechargeable battery of a device, such as DC-DC converters (e.g., flybacks, SEPICs, buck, and buck-boost converters) and/or a voltage regulation device and/or current monitoring circuits.

Meanwhile, the transmitter can include a voltage breakout PCB electrically coupled to the vehicle power supply. This can have a step-down converter for the amplifier digital logic and a boost converter for the amplifier input. The step-down converter for the amplifier digital logic can be buck, flyback, or sepic converter. Furthermore, the voltage breakout board can have EMI filters, fuse protection, and other forms of EMI, short circuit, and reverse-polarity protection circuitry.

The power amplifier can be a switching amplifier, such as a series or parallel, resonant or off-resonant, Class D or Class E amplifier. Additionally, the power amplifier can be single-ended or differential and can comprise an isolated switching amplifier topology. In a parallel-tuned resonant power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier. Further details may be found in commonly owned PCT Patent Application Publication No. WO2020/069198, entitled “PARALLEL TUNED AMPLIFIERS,” which is incorporated by reference herein.

The transmitter amplifier can then be electrically coupled to RF filters, such as bandpass filters, to attenuate undesirable harmonics and spurious signals. The signal then couples with antenna(s) tuned and matched with resonant capacitors.

In current receiver devices, the electronic device is placed directly on top of the receiver antenna and PCB. This is typically due to packaging constraints, for example to physically fit the receiver in a phone case or accessory that can be placed between a device and its case.

However, if it was possible to place the receiver antenna at an angle relative to the placement of the electronic device, the intrinsic ‘Q’ would increase, cross-coupling with nearby metal objects inherently built into the electronic device would decrease, and the flux would better permeate to the receiver antenna and not be blocked as readily by the placement of the device. In general, the more perpendicular the placement of the receiver antenna to the device placement, the better the performance.

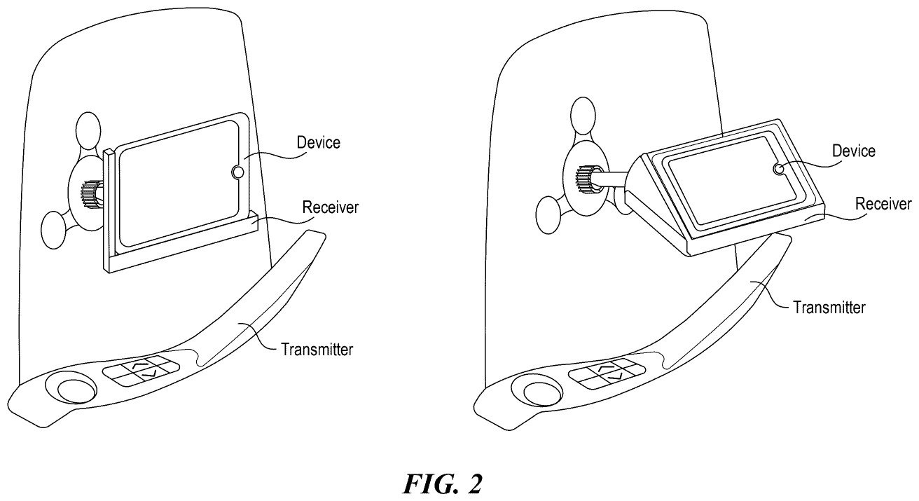

FIG. 2 illustrates an example system implementation of a wireless charging device holder. In particular, FIG. 2 illustrates an example embodiment of the system whereby a receiver holder for a tablet can be mounted to a window of a vehicle above the transmitter unit, which in this example is embedded within the center console. The purpose of the system can be to wirelessly power a tablet over the air to provide additional convenience and functionality for passengers. For vehicle interiors, such as tractor cabins, the wiring for passenger devices can be not only cumbersome, but also dangerous for normal operation. This is because the movement of the command arm and rotation of the seat within the vehicle can interfere with wiring and possible cause wire pinching and be hazardous. The proposed system is not limited to tablets, but also applicable to other passenger devices, such as phones, and embedded electronics within the vehicle, such as monitoring displays and sound systems. Furthermore, the transmitter can be embedded in other applicable areas of the vehicle, such as instrument panels, car seats, and doors to charge electronic devices mounted near the window, such as dash cameras, and electronic devices near car seat headrests.

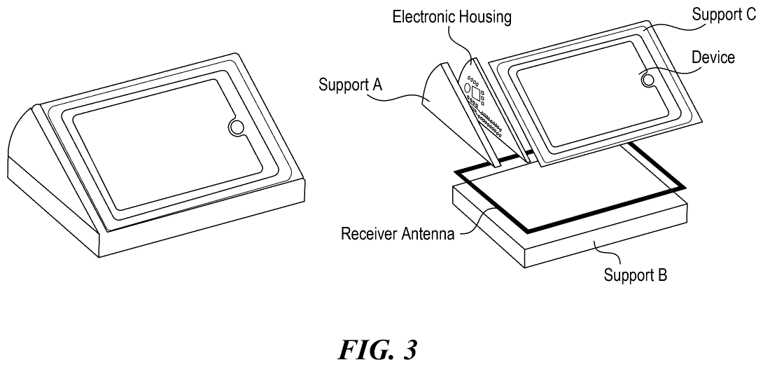

FIG. 3 illustrates an example receiver holder system with antenna, electronic device, and PCB. In particular, FIG. 3 is an example exploded view of a receiver holder system. In this embodiment, the antenna is placed at an acute angle relative to the placement of the electronic device. Furthermore, the electronics for the PCB (e.g., tuning capacitors, the matching network, AC-DC converter, DC-DC converter, and/or voltage regulation device described in FIG. 1) can be mounted parallel to the antenna placement or perpendicular, such as in FIG. 3, to further reduce the flux across the PCB and inductive components. By placing the device in this position, the receiver antenna is positioned approximately parallel to the transmitter to increase the flux linkage and power received. Meanwhile, the device's impact on the intrinsic ‘Q’ and coupling of nearby metallic objects is reduced given the placement of the electronic housing for the PCB and the device, such as a tablet.

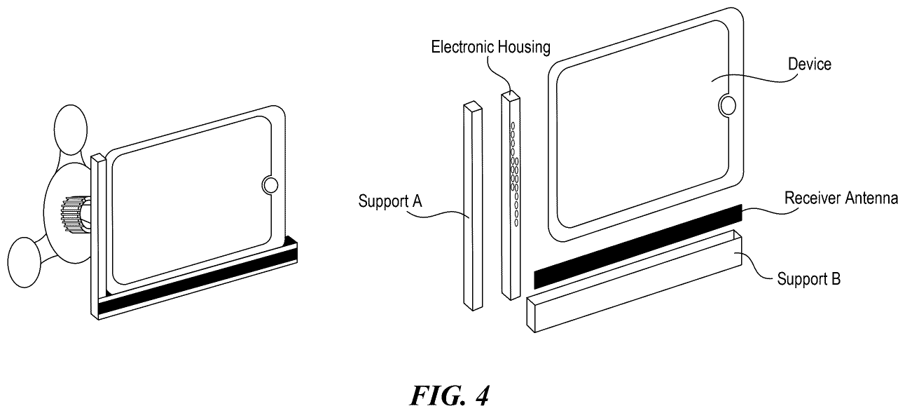

FIG. 4 illustrates an example receiver holder system with perpendicular antenna placement. Similar embodiments can be developed whereby the antenna is positioned more perpendicular relative to the placement of the electronic device rather than acute. In this case, the width of the receiver antenna is typically substantially reduced to meet packaging requirements. This embodiment may be necessary to meet the packaging requirements of a particular application or provide greater convenience to the passengers.

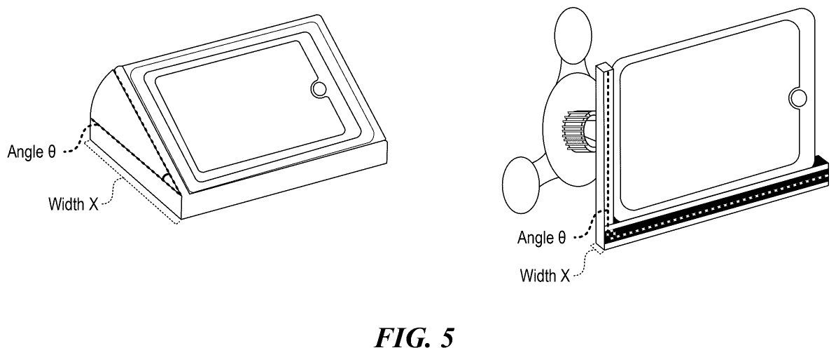

FIG. 5 illustrates an example receiver holder system with labelled receiver antenna width and angle to the electronic device. FIG. 5 compares the width of the receiver antenna and angle of the receiver antenna relative to the electronic device for FIG. 3 and FIG. 4 example embodiments. As illustrated, there can be a range of angles ‘θ’ theta from acute to perpendicular based on the performance and packaging requirements for the system. As the angle become more acute, there is additional packaging space available that can be utilized to further improve the receiver antenna design to better couple with the transmitter. However, this may not be desirable from a passenger experience standpoint because the longer the antenna width X of the receiver holder, the more space it occupies, such as for a window mount application. Furthermore, it is not practical for the receiver holder to become too long because it may cause interference with other devices or people within the vehicle cabin. To summarize, there are multiple iterations that can be developed to meet the performance, cost, and passenger utility objectives by varying the angle θ and width X packaging constraint.

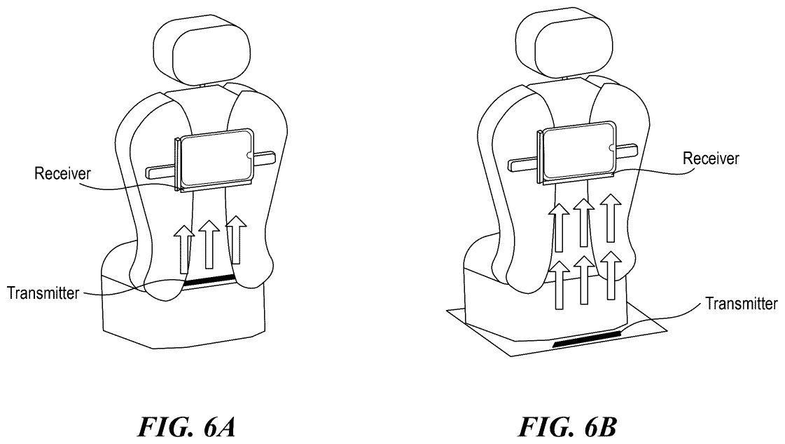

FIG. 6A and FIG. 6B illustrate example receiver holder systems for car seat applications. FIG. 6A illustrates an example receiver holder system for car seat applications with transmitter embedded into car seat, while FIG. 6B illustrates an example receiver holder system for car seat applications with transmitter embedded into the floor of the vehicle. There are also embodiments in which it may be desirable for passengers to place electronic devices, such as phones or tablets, on the back of car seats and headrests for entertainment purposes. In this instance, it may be desirable for the passengers to use their own devices or have the devices be physically removable for different areas of the vehicle. For example, passengers may prefer to use their own devices that already have their preferences and content.

While the FIG. 6A and FIG. 6B embodiments are focused on perpendicular antenna placement, it may also be desirable to have acute placement such as that mentioned in FIG. 3. Furthermore, these implementations can be for car seats in multiple locations throughout the vehicle, such as front row and middle row seats.

FIG. 6A and FIG. 6B also illustrate that the same receiver holder system can be implemented for different transmitter embodiments. Depending on the receiver device mounting location and type of transmitter antenna, there may be different optimal positions for the receiver antenna, which in turn affect the construction of the wireless charging receiver device holder.

In FIG. 6A and FIG. 6B, the transmitter antenna is approximately parallel to the receiver antenna in the receiver device holder when embedded into the bottom cushion (FIG. 6A) of the seat and the floor of the vehicle (FIG. 6B). In these embodiments, it may be optimal to implement a wireless device holder configuration with the receiver antenna positioned approximately perpendicular to that of the device like mentioned in FIG. 4.

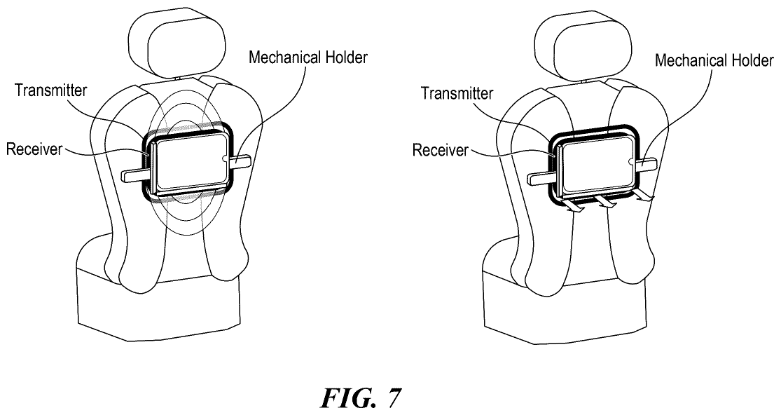

FIG. 7 illustrates an example receiver holder system for car seat applications with transmitter embedded into the back cushion. There are also instances where the transmitter can be embedded into the vehicle product, such as the back of a seat, which causes a different receiver holder construction to be optimal. FIG. 7 illustrates the transmitter embedded into the back of the seat cushion. In this embodiment, the magnetic field from the transmitter indicated by the arrows is perpendicular relative to the position of the transmitter in FIG. 6A and FIG. 6B. Therefore, in this instance, it would be a more optimal construction of the receiver device holder to have the receiver antenna parallel to the transmitter or placed behind the device.

This is an exception case in some embodiments whereby the receiver antenna in the holder is parallel to the electronic device due to the transmitter antenna orientation and construction. If it was possible to place the receiver antenna at an angle relative to the placement of the electronic device, the intrinsic ‘Q’ would increase, cross-coupling with nearby metal objects inherently built into the electronic device would decrease, and the flux would better permeate to the receiver antenna and not be blocked as readily by the placement of the device.

Even though this occurs, the overall distance between the transmitter and receiver is very small, such as less than several centimeters. Therefore, having a high intrinsic ‘Q’ receiver (e.g., greater than or equal to 100) may not be necessary for these applications or may be a secondary consideration.

However, when the field of the transmitter antenna(s) is parallel to the device placement and a higher intrinsic ‘Q’ receiver is required due to performance objectives (e.g., greater than or equal to 100), a separation material and shielding material can be introduced to mitigate the electronic device's placement on target performance. Further details may be found in commonly owned PCT Patent Application Publication No. WO2021/178801, entitled “HIGH INTRINSIC QUALITY RECEIVER CONSTRUCTION,” which is incorporated by reference herein.

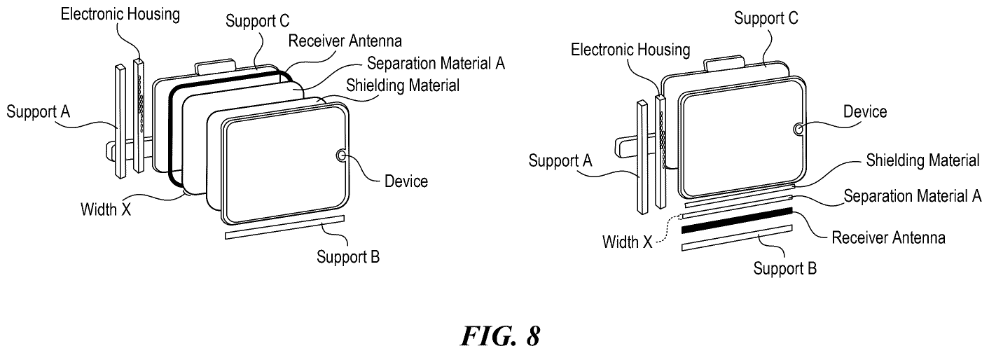

FIG. 8 illustrates an example receiver holder system construction with shielding material and separation material ‘a’ with width ‘x’. When the transmitter's positioning is such that it requires the electronic device to be parallel to the placement of the receiver antenna, a shielding and separation material topology can be implemented to better optimize the system.

The shielding material can be a high permeability, low loss material at the resonating frequency of the system, such as ferromagnetic shielding, and can be positioned such that it is the closest material to the electronic device. Then a separation material ‘a’ with width ‘x’ can be positioned between the shielding material and the receiver antenna. Even though shielding materials have high permeability, the loss of the material itself can reduce the intrinsic quality of the antenna depending on its physical positioning. It is therefore typically not optimal to have the receiver antenna directly on the shielding material. The purpose of the separation material is so that the shielding material is not directly touching the receiver antenna but rather contacting a low dissipation factor plastic, such as polypropylene plastic. The width ‘x’ can be adjusted depending on the ‘Q’ of the receiver antenna but is typically at least several millimeters. In some embodiments, the high permeability may include values such as 50, 100, 200, or another suitable value (μ′) at the operating frequency of the system, while low loss (μ″) in the material may include values such as 1, 2, 5, 10, 20, or another suitable value. For example, the material selected may represent the highest permeability and lowest loss possible from the available options. In some embodiments, the low dissipation factor may include values less than 0.02 or another suitable value. The dissipation factor may vary based on test frequency and material type.

FIG. 8 illustrates two example embodiments for parallel and perpendicular receiver holder structures. It is also possible for the receiver holder system to have the same system stackup for an acute positioning receiver holder system such as that of FIG. 3, but often is not necessary to include due to the positioning of the electronic device relative to the receiver antenna.

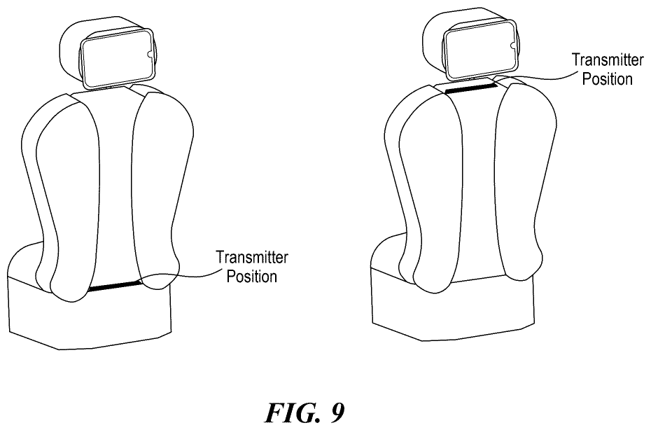

FIG. 9 illustrates an example embedded headrest charging system with different example transmitter mounting locations. The system architectures previously described can also be embedded inside the vehicle part directly, such as embedded into car seats near the headrest or back area. FIG. 9 is an example embodiment of the wireless receiver holder embedded directly into the car seat headrest for a few example transmitter locations. This can again be an implementation for car seats in multiple locations throughout the vehicle, such as front row and middle row seats.

For vehicle seat headrests, it will be difficult to physically wire the display screen, sound system, or other vehicle electronics into the car seat because the headrest can be removed or adjusted by the passenger. Furthermore, for embedded vehicle screens on the back of seats, the wiring can also be cumbersome and potentially cause an increase in warranty and maintenance expenditures for the manufacturer. A wireless power system can enable these features for future vehicles to provide additional convenience to the passenger, while improving system reliability and reducing maintenance, repair, and warranty expenditures.

In this example system, the transmitter can be embedded in the car seat back, near the top of the car seat body, or near the bottom cushion of the seat to provide wireless power to the receiver devices. All transmitters can include previously described features, systems, topologies, and characteristics. The receiver device holder system can again include a receiver antenna placed at an angle or perpendicular relative to the electronic device for improved performance. Furthermore, they can include a receiver holder system with shielding material and separation materials for further system optimization. Both examples in FIG. 9 can also include a receiver device as an aftermarket accessory that plugs into the power port of the passenger's receiver device.

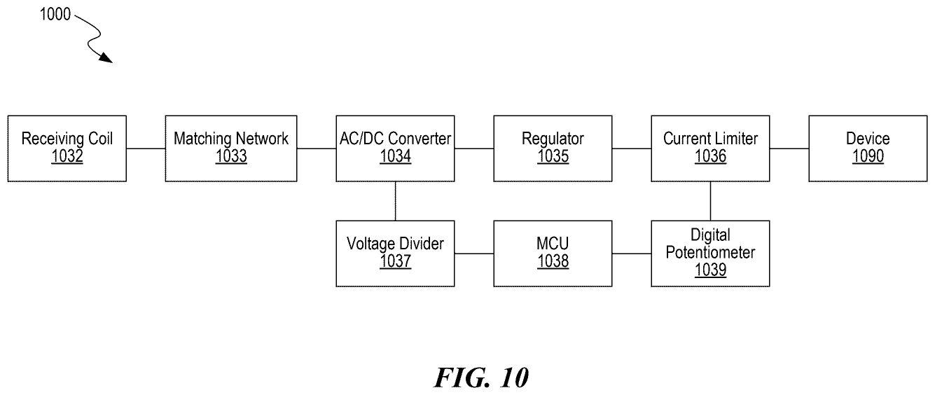

FIG. 10 illustrates an example resonant inductive receiver system programmed for multiple power levels. Because the receiver holder can be placed in various positions by the passenger, it may be desirable to implement a more sophisticated receiver electronics system that can limit the current of the device based on the power available.

For example, if the electronic device's default current draw is 500 mA, the device would not charge if less than 500 mA is provided (e.g., the output voltage would be pulled down as the device attempts to draw more current). Furthermore, if there was a second default limit of say 1 A but 750 mA was available, the current draw would be 500 mA. It is therefore beneficial to limit the current to different levels based on the distance or angular positioning between the transmitter/charger and the receivers and/or to limit the current based on the unregulated AC-DC voltage output or the available power to provide a more customized experience. For example, when the wireless power receiver is further away from the wireless power transmitter, current limiter 336 can provide a lower current limit than when the receiver is closer to the transmitter. This allows for a greater degree of flexibility in the wireless charging system. Further details may be found in commonly owned PCT Patent Application Publication No. WO2022/109604, entitled “RESONANT INDUCTIVE RECEIVER SYSTEM,” which is incorporated by reference herein.

Resonant inductive receiver 300 monitors the unregulated AC-DC voltage output in real-time, and selects pre-determined thresholds programmed in the microcontroller (MCU) 338. For example, a voltage divider 337 drives a portion of the unregulated AC-DC output voltage from AC-DC converter 334 to the MCU 338 (e.g., via a low output impedance buffer such as an op amp). The MCU 338 selects different resistance values of a digital potentiometer 339 to change the current limit for the device using current limiter 336. In some embodiments, a first distance corresponds to a first output voltage of the AC-DC converter 334 and the second distance corresponds to a second output voltage of the AC-DC converter. If the first distance is larger than the second distance, the first voltage is lower than the second voltage, and the current limit level selected for the first distance is lower than the second current level for the second distance. Further details may be found in commonly owned PCT Patent Application Publication No. WO2022/109604, entitled “RESONANT INDUCTIVE RECEIVER SYSTEM,” which is incorporated by reference herein.

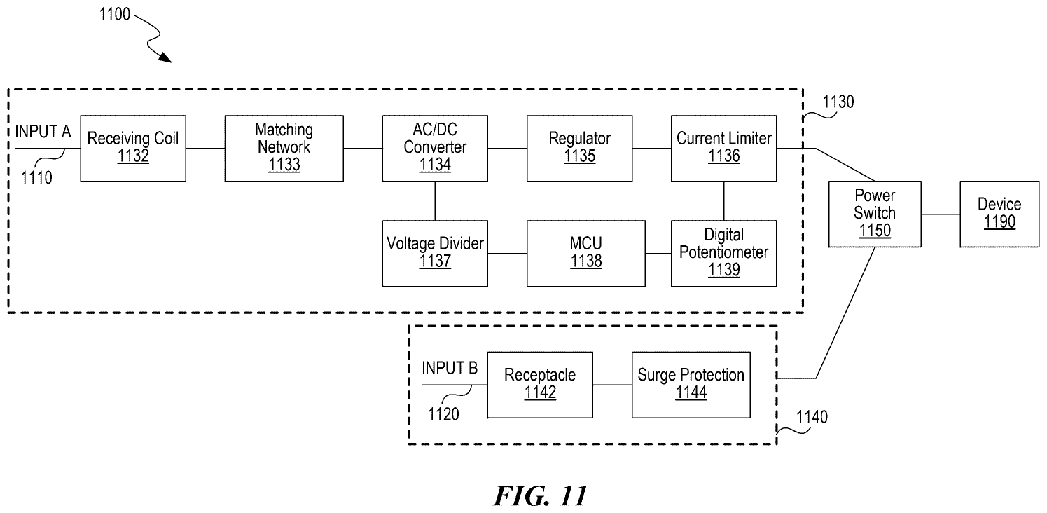

FIG. 11 illustrates an example resonant inductive receiver system programmed for multiple power levels with pass-through connector. It may also be desirable to include a pass-through connector for the receiver device holder system being used in case the wireless charging system is disabled, too far away from the transmitter, or too cumbersome to enable.

FIG. 11 is a representative block diagram 400 of a resonant inductive receiver with a power pass-through connector. A receiving coil 432 receives wireless power from a wireless charging transmitter (not shown in FIG. 11) (this received wireless power is represented as “input A” 410 in FIG. 11). In this representative embodiment, the wireless power receiver 400 includes an additional power charging port or pass-through connector, e.g., a receptacle connector 442 (e.g., female receptable) in the wireless charging phone case in which the receiver 400 is embedded, that allows the device 490 to receive another power input (represented as “input B” 420 in FIG. 11). The alternative power input from the pass-through connector (receptable 442) goes through a surge protection circuit 444 and is switched onto the device 490 by a power switch 450. The receptacle 442 on the receiver 400 PCB is available for a user to plug a charging cord (or data cord) while the device 490 is inside the phone case. This provides additional user convenience as the user need not remove the mobile device from the phone case to charge the device using a wall charger, for example, when a wireless charging transmitter is not available (or is too far away). The resonant inductive receiver of FIG. 11 is also applicable to other types of devices as described above including tablets, computers, headphones, game controllers, and other wireless communication devices.

The following listing of solutions may be preferably implemented by some embodiments.
1. A wireless power system for installation in proximity to a window of a vehicle, comprising: a receiver holder configured to receive an electronic device for wireless charging, the receiver holder configured to be mounted to the window of the vehicle and comprising: a receiver antenna placed at an acute angle or perpendicular relative to a placement of the electronic device and placed parallel relative to a transmitter unit; and a printed circuit board placed parallel or perpendicular to the receiver antenna, wherein the printed circuit board includes tuning capacitors, a matching network, an AC-DC converter, a DC-DC converter, and/or a voltage regulation device; and the transmitter unit configured to transmit wireless power to the receiver holder, the transmitter unit configured to be embedded near the receiver holder within a console, a pillar, a panel, a car seat, or a door of the vehicle, wherein one or many transmitter and receiver antennas substantially resonate with capacitors at similar frequencies.
2. The wireless power system of solution 1, wherein the printed circuit board is placed such that an impact of the electronic device on an intrinsic ‘Q’ value and coupling of nearby metallic objects is reduced.
3. The wireless power system of solutions 1-2, wherein the receiver antenna is placed parallel to the transmitter unit to increase flux linkage and wireless power received.
4. The wireless power system of solutions 1-3, wherein the transmitter unit is located near the receiver holder to provide wireless power for one or more removable devices including tablets, phones, infotainment systems, game controllers, headphones, sound systems and/or computers.
5. The wireless power system of solutions 1-4, wherein the transmitter unit is located near the receiver holder to provide wireless power for one or more embedded devices including monitoring displays, infotainment systems, sound systems, and/or dash cameras.
6. The wireless power system of solutions 1-5, wherein a position of the transmitter unit is such that the electronic device is disposed parallel to the receiver antenna, and wherein the receiver holder comprises shielding and separation material topology that includes a shielding material with high permeability and low loss and a separation material with low dissipation factor to mitigate loss of wireless power.
7. The wireless power system of solution 6, wherein the shielding and separation material topology includes the shielding material with high permeability and low loss positioned to be a material closest to the electronic device.
8. The wireless power system of solution 7, wherein the shielding and separation material topology includes the separation material with a low dissipation factor positioned between the shielding material and the receiver antenna.
9. A wireless power system for installation in proximity to a car seat of a vehicle, comprising: a receiver holder configured to receive an electronic device for wireless charging, the receiver holder configured to be mounted to the car seat of the vehicle and comprising: a receiver antenna placed at an acute angle or perpendicular relative to a placement of the electronic device and placed parallel relative to a transmitter unit; and a printed circuit board placed parallel or perpendicular to the receiver antenna, wherein the printed circuit board includes tuning capacitors, a matching network, an AC-DC converter, a DC-DC converter, and/or a voltage regulation device; and the transmitter unit configured to transmit wireless power to the receiver holder, the transmitter unit configured to be embedded near the receiver holder within the car seat or under a floor of the vehicle, wherein one or many transmitter and receiver antennas substantially resonate with capacitors at similar frequencies.
10. The wireless power system of solution 9, wherein the receiver holder configured to be mounted to the car seat includes the receiver holder configured to be mounted to a head rest and/or a back of the car seat.
11. The wireless power system of solutions 9-10, wherein the transmitter unit configured to be embedded within the car seat includes the transmitter unit configured to be embedded within a top, a back, and/or a bottom cushion of the car seat.
12. The wireless power system of solutions 9-11, wherein a position of the transmitter unit is such that the electronic device is disposed parallel to the receiver antenna, and wherein the receiver holder comprises shielding and separation material topology that includes a shielding material with high permeability and low loss and a separation material with low dissipation factor to mitigate loss of wireless power.
13. The wireless power system of solution 12, wherein the shielding and separation material topology includes the shielding material with high permeability and low loss positioned to be a material closest to the electronic device.
14. The wireless power system of solution 13, wherein the shielding and separation material topology includes the separation material with low dissipation factor positioned between the shielding material and the receiver antenna.
15. The wireless power system of solutions 9-14, wherein the transmitter unit is located near the receiver holder to provide wireless power for one or more removable devices including tablets, phones, infotainment systems, game controllers, headphones, sound systems, and/or computers.
16. The wireless power system of solutions 9-14, wherein the transmitter unit is located near the receiver holder to provide wireless power for one or more embedded devices including monitoring displays, infotainment systems, and/or sound systems.

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A wireless power system for installation in proximity to a window of a vehicle, comprising:
a receiver holder configured to receive an electronic device for wireless charging, the receiver holder configured to be mounted to the window of the vehicle and comprising:
a receiver antenna placed at an acute angle or perpendicular relative to a placement of the electronic device and placed parallel relative to a transmitter unit; and
a printed circuit board placed parallel or perpendicular to the receiver antenna,
wherein the printed circuit board includes tuning capacitors, a matching network, an AC-DC converter, a DC-DC converter, and/or a voltage regulation device;
and the transmitter unit configured to transmit wireless power to the receiver holder, the transmitter unit configured to be embedded near the receiver holder within a console, a pillar, a panel, a car seat, or a door of the vehicle,
wherein one or many transmitter and receiver antennas substantially resonate with capacitors at similar frequencies.

2. The wireless power system of claim 1, wherein the printed circuit board is placed such that an impact of the electronic device on an intrinsic ‘Q’ value and coupling of nearby metallic objects is reduced.

3. The wireless power system of claim 1, wherein the receiver antenna is placed parallel to the transmitter unit to increase flux linkage and wireless power received.

4. The wireless power system of claim 1, wherein the transmitter unit is located near the receiver holder to provide wireless power for one or more removable devices including tablets, phones, infotainment systems, game controllers, headphones, sound systems, and/or computers.

5. The wireless power system of claim 1, wherein the transmitter unit is located near the receiver holder to provide wireless power for one or more embedded devices including monitoring displays, infotainment systems, sound systems, and/or dash cameras.

6. The wireless power system of claim 1, wherein a position of the transmitter unit is such that the electronic device is disposed parallel to the receiver antenna, and wherein the receiver holder comprises shielding and separation material topology that includes a shielding material with high permeability and low loss and a separation material with low dissipation factor to mitigate loss of wireless power.

7. The wireless power system of claim 6, wherein the shielding and separation material topology includes the shielding material with high permeability and low loss positioned to be a material closest to the electronic device.

8. The wireless power system of claim 7, wherein the shielding and separation material topology includes the separation material with a low dissipation factor positioned between the shielding material and the receiver antenna.

9. A wireless power system for installation in proximity to a car seat of a vehicle, comprising:
a receiver holder configured to receive an electronic device for wireless charging, the receiver holder configured to be mounted to the car seat of the vehicle and comprising:
a receiver antenna placed at an acute angle or perpendicular relative to a placement of the electronic device and placed parallel relative to a transmitter unit; and
a printed circuit board placed parallel or perpendicular to the receiver antenna,
wherein the printed circuit board includes tuning capacitors, a matching network, an AC-DC converter, a DC-DC converter, and/or a voltage regulation device;
and the transmitter unit configured to transmit wireless power to the receiver holder, the transmitter unit configured to be embedded near the receiver holder within the car seat or under a floor of the vehicle,
wherein one or many transmitter and receiver antennas substantially resonate with capacitors at similar frequencies.

10. The wireless power system of claim 9, wherein the receiver holder configured to be mounted to the car seat includes the receiver holder configured to be mounted to a head rest and/or a back of the car seat.

11. The wireless power system of claim 9, wherein the transmitter unit configured to be embedded within the car seat includes the transmitter unit configured to be embedded within a top, a back, and/or a bottom cushion of the car seat.

12. The wireless power system of claim 9, wherein a position of the transmitter unit is such that the electronic device is disposed parallel to the receiver antenna, and wherein the receiver holder comprises shielding and separation material topology that includes a shielding material with high permeability and low loss and a separation material with low dissipation factor to mitigate loss of wireless power.

13. The wireless power system of claim 12, wherein the shielding and separation material topology includes the shielding material with high permeability and low loss positioned to be a material closest to the electronic device.

14. The wireless power system of claim 13, wherein the shielding and separation material topology includes the separation material with a low dissipation factor positioned between the shielding material and the receiver antenna.

15. The wireless power system of claim 9, wherein the transmitter unit is located near the receiver holder to provide wireless power for one or more removable devices including tablets, phones, infotainment systems, game controllers, headphones, sound systems, and/or computers.

16. The wireless power system of claim 9, wherein the transmitter unit is located near the receiver holder to provide wireless power for one or more embedded devices including monitoring displays, infotainment systems, and/or sound systems.
